(19) United States
(12) Patent Application Publication
(10) Pub. No.: US 2003/0118814 A1
(43) Pub. Date: Jun. 26, 2003

(54) Absorbent structures having low melting fibers

(76) Inventors: Jerome James Workman JR., Appleton, WI (US); Francis Paul Abuto, Duluth, GA (US); Vasily Aramovich Topolkaraev, Appleton, WI (US); Palani Raj Ramaswami Wallajapet, Neenah, WI (US); Peiguang Zhou, Appleton, WI (US)

Correspondence Address: KIMBERLY-CLARK WORLDWIDE, INC., 401 NORTH LAKE STREET, NEENAH, WI, 54956

(21) Appl. No.: 10/034,021

(22) Filed: Dec. 20, 2001

(51) Int. Cl. B32B 5/02; B32B 27/02; B32B 27/04; D04H 1/00; D02G 3/00; B32B 9/00; B32B 15/02

(52) U.S. Cl. 428/365; 442/327; 442/110; 442/334; 442/361; 442/415; 442/416; 428/391; 428/402

(57) ABSTRACT

A nonwoven structure is provided having a fiber with a lower melting point than conventional fibers, preferably less than 110° C., more particularly less than 90° C., more particularly less than 80° C. The fiber may also include an energy receptive additive that provides rapid heating when subjected to dielectric energy such as radio frequency or microwave radiation. When included in a structure and subjected to electromagnetic radiation, the fiber is heated by contact with materials like pulp and superabsorbent, which absorb electromagnetic radiation.

### BACKGROUND OF THE INVENTION

This invention relates generally to nonwoven structures made from thermoplastic fibers.

Thermoplastic resins have been extruded to form fibers, fabrics and webs for a number of years. Common thermoplastics for this application are polyolefins, particularly polyethylene and polypropylene. Other materials such as polyesters, polyetheresters, polyamides and polyurethanes are also used to form nonwoven fabrics.

Nonwoven fabrics or webs are useful for a wide variety of applications such as personal care products, towels, recreational or protective fabrics and as geotextiles and filter media. The nonwoven fibers used in these applications may be made by many processes known in art, such as spunbonding and meltblowing. Nonwoven fibers may be processed into webs through bonding and carding processes, airforming (airlaying), and other processes.

Fibers are commonly consolidated to form a web by adhesive bonding, mechanical bonding such as hydroentangling and by ultrasonic and thermal bonding processes using bonding fibers. These processes work well but have individual idiosyncratic drawbacks. Adhesive bonding and hydroentangling, for example, necessitate the removal of water, a process involving the addition of more energy for a rather lengthy time. Ultrasonic bonding is also an energy intensive activity involving energy being added somewhat randomly to a web. Thermal bonding also involves the addition of energy to the web in a relatively slow process to melt particular binder fibers.

A nonwoven fabric wherein the binder fibers have a reduced melting point as compared to conventional fibers so they could be heated more rapidly to their melting temperature, would be very advantageous for high-speed industrial applications. The difficulty is in composing the specific blend of materials for the binder fibers that will absorb sufficient energy at line speeds so as to create the appropriate absorbent structure. This approach requires very highly selective “lossy” materials, in the form of fibers, which are capable of converting microwave energy to heat in order that melting occurs at specific bond points within the absorbent structure. The difficulty is in finding and creating materials with sufficient loss (i.e., microwave-receptivity). The combination of an improved binder fiber that could reach its lower melting temperature under the proper conditions in a matter of fractions of a second, with other materials that were of the proper microwave receptivity, would significantly reduce processing and production time and thus increase manufacturing efficiency and reduce product cost. It is an object of this invention to produce such a fabric.

### SUMMARY OF THE INVENTION

The objects of this invention are achieved by a nonwoven structure having less than 5 times more oxidation at its outer surface than at its center and more particularly less than 3 times more oxidation at its outer surface than at its center. The structure may include superabsorbent, natural fibers and a low melting fiber. The low melting polymer may be chosen from among low density PE/polyethylene-polyvinylacetate block copolymer, LDPE/polyethylene glycol, PE/polyacrylates, polyethylene-vinyl acetate copolymer, polyester, polycaprolactone, polyurethane, polyacrylates, polyethylene glycol (PEG), polyacrylamide (PAA), polyethylenimine (PEEM), polyvinyl acetate (PVAC), polyvinyl alcohol (PVA), polymethylacylic acid-sodium salt (PMA-Na), polyacylic acid sodium salt (PA-Na), and poly (styrene solfonate-co-methyl acylic acid) sodium salt (P (SS-co-MA)-Na). The low melting binder fiber has a melting point of at most 110° C. more particularly at most 80° C. and still more particularly at most 60° C.

The fiber may be is a biconstituent fiber. The fiber may further be made from a base polymer containing an energy receptive additive having a dielectric loss of at least 0.5, more particularly at least 1 and still more particularly at least 5, up to 15.

The energy receptive additive may be chosen from carbon black, magnetite, silicon carbide, calcium chloride, zircon, magnetite, silicon carbide, calcium chloride, alumina, magnesium oxide, and titanium dioxide.

The fiber of the nonwoven web may have the energy receptive additive present in an amount between 2 and 40 weight percent, more particularly between 5 and 15 weight percent.

A particular embodiment of the nonwoven web has superabsorbent in an amount of from 0 to 80 weight percent, natural fibers in an amount from about 5 to 98 weight percent and low melting point fibers in an amount of from about 1 to 60 weight percent, where the low melting point fiber has a melting point of at most 110° C.

The nonwoven structure of claim may have the superabsorbent, natural fibers and binder fibers homogeneously mixed. Alternatively, the superabsorbent, natural fibers and binder fibers may be heterogeneously mixed, more particularly the binder fibers, density and/or thickness may vary in concentration in the X-Y plane or in the Z-direction.

The nonwoven web may have superabsorbent in the form of ribbons, particles, fibers, sheets and films. The nonwoven web may have natural fiber in the form of wool, cotton, flax, hemp and wood pulp.

Another particular embodiment is a nonwoven web with from about 4 to 12 weight percent low melting point fiber, 30 to 70 weight percent superabsorbent and 30 to 70 weight percent natural fiber. This web may have a basis weight of about 30-2500 gsm. The average basis weight of the fibrous web can alternatively be within the range of about 50-2000 gsm, and can optionally be within the range of about 100-1500 gsm. This nonwoven web may further have an energy receptive additive having a dielectric loss of at least 5 and as much as 15.

### BRIEF DESCRIPTION OF THE DRAWINGS

FIG. 1 is a graph of the heating depth profiles for infrared/convection versus dielectric heating.

FIG. 2 is a graph of the oxidation depth profiles for infrared/convection versus dielectric heating.

### DEFINITIONS

As used herein the term “nonwoven fabric or web” means a web having a structure of individual fibers or threads which are interlaid, but not in an identifiable manner as in a knitted fabric. Nonwoven fabrics or webs have been formed from many processes such as for example, meltblowing processes, spunbonding processes, and bonded carded web processes. The basis weight of nonwoven fabrics is usually expressed in ounces of material per square yard (osy) or grams per square meter (gsm) and the fiber diameters useful are usually expressed in microns. (Note that to convert from osy to gsm, multiply osy by 33.91). A nonwoven “structure” may contain only one layer or multiple layers.

As used herein the term “meltblown fibers” means fibers formed by extruding a molten thermoplastic material through a plurality of fine, usually circular, die capillaries as molten threads or filaments into converging high velocity, usually hot, gas (e.g. air) streams which attenuate the filaments of molten thermoplastic material to reduce their diameter, which may be to microfiber diameter. Thereafter, the meltblown fibers are carried by the high velocity gas stream and are deposited on a collecting surface to form a web of randomly dispersed meltblown fibers. Such a process is disclosed, for example, in U.S. Pat. No. 3,849,241 to Butin et al. Meltblown fibers are microfibers which may be continuous or discontinuous, are generally smaller than 10 microns in average diameter, and are generally tacky when deposited onto a collecting surface.

“Spunbonded fibers” refers to small diameter fibers that are formed by extruding molten thermoplastic material as filaments from a plurality of fine capillaries of a spinneret. Such a process is disclosed in, for example, U.S. Pat. No. 4,340,563 to Appel et al. and U.S. Pat. No. 3,802,817 to Matsuki et al. The fibers may also have shapes such as those described, for example, in U.S. Pat. No. 5,277,976 to Hogle et al. which describes fibers with unconventional shapes.

As used herein the term “bicomponent fibers” refers to fibers which have been formed from at least two polymers extruded from separate extruders but spun together to form one fiber. Bicomponent fibers are also sometimes referred to as multicomponent or conjugate fibers. The polymers are usually different from each other though bicomponent fibers may be monocomponent fibers. The polymers are arranged in substantially constantly positioned distinct zones across the cross-section of the bicomponent fibers and extend continuously along the length of the bicomponent fibers. The configuration of such a bicomponent fiber may be, for example, a sheath/core arrangement wherein one polymer is surrounded by another or may be a side by side arrangement, a pie arrangement or an “islands-in-the-sea” arrangement. Bicomponent fibers are taught in U.S. Pat. No. 5,108,820 to Kaneko et al., U.S. Pat. No. 4,795,668 to Krueger et al., U.S. Pat. No. 5,540,992 to Marcher et al. and U.S. Pat. No. 5,336,552 to Strack et al. Bicomponent fibers are also taught in U.S. Pat. No. 5,382,400 to Pike et al. and may be used to produce crimp in the fibers by using the differential rates of expansion and contraction of the two (or more) polymers. For two component fibers, the polymers may be present in ratios of 75/25, 50/50, 25/75 or any other desired ratios. The fibers may also have shapes such as those described in U.S. Pat. No. 5,277,976 to Hogle et al., U.S. Pat. No. 5,466,410 to Hills and U.S. Pat. Nos. 5,069,970 and 5,057,368 to Largman et al., which describe fibers with unconventional shapes.

As used herein the term “biconstituent fibers” refers to fibers which have been formed from at least two polymers extruded from the same extruder as a blend. The term “blend” is defined below. Biconstituent fibers do not have the various polymer components arranged in relatively constantly positioned distinct zones across the cross-sectional area of the fiber and the various polymers are usually not continuous along the entire length of the fiber, instead usually forming fibrils or protofibrils which start and end at random. Biconstituent fibers are sometimes also referred to as multiconstituent fibers. Fibers of this general type are discussed in, for example, U.S. Pat. Nos. 5,108,827 and 5,294,482 to Gessner. Bicomponent and biconstituent fibers are also discussed in the textbook Polymer Blends and Composites by John A. Manson and Leslie H. Sperling, copyright 1976 by Plenum Press, a division of Plenum Publishing Corporation of New York, ISBN 0-306-30831-2, at pages 273 through 277.

As used herein the term “blend” means a mixture of two or more polymers while the term “alloy” means a sub-class of blends wherein the components are immiscible but have been compatibilized. “Miscibility” and “immiscibility” are defined as blends having negative and positive values, respectively, for the free energy of mixing. Further, “compatibilization” is defined as the process of modifying the interfacial properties of an immiscible polymer blend in order to make an alloy.

“Bonded carded web” refers to webs that are made from staple fibers which are sent through a combing or carding unit, which separates or breaks apart and aligns the staple fibers in the machine direction to form a generally machine direction-oriented fibrous nonwoven web. This material may be bonded together by methods that include point bonding, through air bonding, ultrasonic bonding, adhesive bonding, etc.

“Airlaying” is a well-known airforming process by which a fibrous nonwoven layer can be formed. In the airlaying process, bundles of small fibers having typical lengths ranging from about 3 to about 52 millimeters (mm) are separated and entrained in an air supply and then deposited onto a forming screen, usually with the assistance of a vacuum supply. The randomly deposited fibers then are bonded to one another using, for example, hot air or a spray adhesive. The production of airlaid nonwoven composites is well defined in the literature and documented in the art. Examples include the DanWeb process as described in U.S. Pat. No. 4,640,810 Laursen et al. and assigned to Scan Web of North America Inc, the Kroyer process as described in U.S. Pat. No. 4,494,278 Kroyer et al. and U.S. Pat. No. 5,527,171 Soerensen assigned to Niro Separation a/s, the method of U.S. Pat. No. 4,375,448 Appel et al assigned to Kimberly-Clark Corporation, or other similar methods.

“Personal care product” means products for the absorption of body exudates, such as diapers, training pants, disposable swim wear, absorbent underpants, adult incontinence products, bandages, veterinary and mortuary products, and feminine hygiene products like sanitary napkins and pantiliners.

The “dielectric loss” is a measure of how receptive to high frequency energy a material is. The measured value of ∈′ is most often referred to as the dielectric constant, while the measurement of ∈″ is denoted as the dielectric loss factor. These are measured directly using a Network Analyzer with a low power external electric field (i.e., 0 dBm to +5 dBm) typically over a frequency range of 300 kHz to 3 GHz, although Network Analyzers to 20 GHz are readily available, for example, the 8720D Dielectric Probe available from the Hewlett-Packard Company (HP). By definition, ∈″ is always positive, and a value of less than zero is occasionally observed when ∈″ is near zero due to the measurement error of the analyzer. The “loss tangent” is defined as the calculated ratio of ∈″/∈′. This loss tangent results as the vector sum of the orthogonal real (∈′) and imaginary (∈″) parts of the complex relative permittivity (∈ᵣ) of a sample. The vector sum of the real and imaginary vectors creates an angle (δ) where tan δ is the analytical geometry equivalent to the ratio of ∈″/∈′. The application of the mathematical relationships and measurements discussed allows an estimation of the microwave affinity or microwave-receptivity for a particular material subjected to a microwave field.

### DETAILED DESCRIPTION

Related material is disclosed in U.S. patent application Ser. No. ______ entitled TARGETED BONDING FIBERS FOR STABILIZED ABSORBENT STRUCTURES by F. Abuto et al., (attorney docket No. 15,708); in U.S. patent application Ser. No. ______ entitled ABSORBENT STRUCTURES HAVING LOW MELTING FIBERS by J. Workman et al. (attorney docket No. 15,708B); and in U.S. patent application Ser. No. ______ entitled TARGETED ON-LINE STABILIZED ABSORBENT STRUCTURES by F. Abuto et al., (attorney docket No. 17,527) and U.S. patent application Ser. No. ______ entitled METHOD AND APPARATUS FOR MAKING ON-LINE STABILIZED ABSORBENT MATERIALS by T. Rymer et al., all of which were filed contemporaneously herewith on Dec. 20^{th}, 2001 (attorney docket No. 16820). The entire disclosures of these documents are incorporated herein by reference in a manner that is consistent herewith.

The bonding together of nonwoven webs has been performed by a number of processes that involve the addition of energy to the entire web to bonding of only particular points on the web. One common process is thermal bonding wherein the web is heated until the melting point of one of the component fibers is reached. The melted fiber bonds to other fibers in the web as it cools to give the web integrity. This process is slow because of the relatively high melting temperatures of conventional binder fibers, between about 115 and 180° C. and even higher. Fibers that melt or soften at lower temperatures, preferably less than 110° C., more particularly less than 90° C., still more particularly less than 80° C. are desired in the practice of this invention.

The inventors have found that specific characteristics of the bulk matrix materials surrounding low melting temperature polymer fibers can act as a source of heat to indirectly transfer microwave energy to melt the low melting temperature fibers. The matrix acts as the energy receptive material, and is excited to melt the adjacent low melt temperature polymers and so bond the web. This allows the low melt temperature polymers to reach their respective melting temperatures much more rapidly than it would without the heating of the matrix material. This melting will depend on a number of factors such as microwave generator power, moisture content, specific heat, and density of the matrix materials, fiber denier, which is generally between 1 and 20, as well as the composition, and concentration, of the low melt temperature polymers.

The low melting temperature fiber or binder material used should have a low specific heat to allow rapid heating and cooling of the material. The low specific heat is useful during the heating cycle, as the heat absorbed by the binder before melting is low. This enables rapid heating of the binder material in-line. The low specific heat is also useful during the cooling cycle of the process, as the heat to be removed from the material to cause it to solidify and stabilize the web will be lower. A good specific heat range of a material is in the range of 0.1 to 0.6 calories/gram.

High thermal conductivity is a beneficial for binders for this application. A high thermal conductivity enables rapid transfer of heat through the binder material. Thermal conductivity is proportional to density and heat capacity/specific heat capacity of the material. It is beneficial to achieve higher thermal conductivity using fibers with relatively high density. The fibers having a density more than about 0.94 g/cc are beneficial for this application. This is helpful in accelerating the heating and cooling cycles during activation of the binder material during in-line stabilization of the web. It is preferred that the thermal conductivity be greater than 0.1 joules-sec⁻¹-mole⁻¹-degree Kelvin⁻¹. High thermal conductivity is beneficial for binder fibers for this application.

Materials with low melting enthalpy are useful as binders for this application. The low melting enthalpy reduces the energy requirement for transformation of the binder from the solid to molten state during the heating cycle and from the liquid to solid state during the cooling cycle. This characteristic of the binder material will be useful in achieving high speed processing. It is preferred that the melting enthalpy be less than 100 joules/gram, more particularly less than 75 joules/gm and most particularly less than 60 joules/gm.

The binder material for this application should have low melt viscosity after melting is achieved. This will enable the binder to flow to the junction points between fibers and form stable bonds. It is preferred that the melt viscosity be less than 100,000 centipoise, more particularly less than 20,000 centipoise and most particularly less than 10,000 centipoise.

The binder material should have adequate surface energy to be wettable to the fluid being absorbed by the structure. This wettability is not required in all applications, however, and may be accomplished using various surfactants known to those skilled in the art if the fiber is not intrinsically wettable.

In addition to lower melting fibers, energy receptive additives may be added to the fiber composition. These additives absorb energy, such as radio frequency (RF) or microwave energy, more rapidly than other materials. When incorporated into a fiber, the fiber will heat faster than a fiber without the additive. A successful energy receptive additive should have a dielectric loss factor that is relatively high. Exemplary energy receptive additives include carbon black, magnetite, silicon carbide, calcium chloride, zircon, magnetite, silicon carbide, calcium chloride, alumina, magnesium oxide, and titanium dioxide. A more comprehensive discussion of such additives may be found in U.S. patent application Ser. No. _______, attorney docket number 15708, filed the same day as this application and co-assigned.

Conventional synthetic fibers include those made from synthetic polymers like polyolefins, polyamides, polyetheramides, polyurethanes, polyesters, poly (meth) acrylates metal salts, polyether, poly(ethylene-vinyl acetate) random and block copolymers, polyethylene-b-polyethylene glycol block copolymers, polypropylene oxide-b-polyethylene oxide copolymers (and blends thereof).

The inventors have found novel low melting fibers made from polyethylene-polyvinyl alcohol (PE-PVA) block or random copolymers, polyethylene-polyethylene oxide (PE-PEO) block/graft copolymers, polypropylene-polyethylene oxide (PP-PEO) block/graft copolymers, polyester, polycaprolactone, polyamide, polyacrylates, polyurethane (ester or ether based). The melting point can be adjusted by adjusting the content of VA or PEO (for those polymers with VA and PEO) or the configuration. The fiber can be made by compounding with twin extruder or Sigma mixer or other compounding equipment and then made into fiber by conventional non-woven processes like meltblowing and spunbonding. Such fibers may also be cut to staple lengths and processed by bonding and carding and airforming techniques.

In addition to the energy receptive additives discussed above, a number of other polymers and sensitizers may be used. Specifically selecting moieties along the polymer chain and the positioning of moieties along the polymer chain can affect the dielectric loss factor of the polymer and enhance the responsiveness of the polymer to electromagnetic energy. These include polymer composites from blend, block, graft, random copolymers, ionic polymers and copolymers and metal salts. Desirably, the presence of one or more moieties along the polymer chain causes one or more of the following: (1) an increase in the dipole moments of the polymer; and (2) an increase in the unbalanced charges of the polymer molecular structure. Suitable moieties include, but not limited to, aldehyde, ester, carboxylic acid, sulfonamide and thiocyanate groups.

The selected moieties may be covalently bonded or ionically attached to the polymer chain. As discussed above, moieties containing functional groups having high dipole moments are desired along the polymer chain. Suitable moieties include, but are not limited to, urea, sulfone, amide, nitro, nitrile, isocyanate, alcohol, glycol and ketone groups. Other suitable moieties include moieties containing ionic groups including, but are not limited to, sodium, zinc, and potassium ions.

For example, a nitro group may be attached to an aryl group within the polymer chain. It should be noted that the nitro group may be attached at the meta or para position of the aryl group. Further, it should be noted that other groups may be attached at the meta or para position of the aryl group in place of the nitro group. Suitable groups include, but are not limited to, nitrile groups. In addition to the these modifications, one could incorporate other monomer units into the polymer to further enhance the responsiveness of the resulting polymer. For example, monomer units containing urea and/or amide groups may be incorporated into the polymer.

Suitable moieties include aldehyde, ester, carboxylic acid, sulfonamide and thiocyanate groups. However, other groups having or enhancing unbalanced charges in a molecular structure can also be useful; or a moiety having an ionic or conductive group such as, e.g., sodium, zinc, and potassium ions. However, other ionic or conductive groups can also be used.

Specific combinations include low density PE/polyethylene-polyvinylacetate block copolymer, LDPE/polyethylene glycol, PE/polyacrylates, polyethylene-vinyl acetate copolymer, polyester, polyurethane, polyacrylates, polyethylene glycol (PEG), polyacrylamide (PAA), polyethylenimine (PEEM), polyvinyl acetate (PVAC), polyvinyl alcohol (PVA), polymethylacylic acid-sodium salt (PMA-Na), polyacylic acid sodium salt (PA-Na), and poly (styrene solfonate-co-methyl acylic acid) sodium salt (P (SS-co-MA)-Na), and polymers of terephathalic acid, adipic acid and 1, 4 butanediol, and polybutylene succinate copolymers. Other materials include polymers of terephtalic acid, adipic acid and 1,4-butanediol, sold by BASF Corporation under the name ECOFLEX® or by Eastman Chemical Co. under the name Eastar BiO™ copolyester. Blends and grafted copolymers of the above listed polymers are also suitable for the invention.

As an alternative to the selection of materials with precise microwave-receptivity, the fibers may be incorporated into a nonwoven structure with other components where these other components serve to absorb microwave energy and convert it to heat. One example of this structure contains the low melting point fibers, natural fibers and superabsorbent material (SAM). Prior to the microwave processing step the natural fiber and SAM must be of a pre-specified moisture content and temperature. Careful control of these variables will ensure specific heat conversion and reduce the possibility of thermal damage or fire within the structure. The heat generated within the natural fibers would be used to melt the polymer fibers having sufficiently low melting temperature so as to assure bonding and the resultant formation of appropriate stabilized absorbent structures.

A description of the essential characteristics of natural fibers and SAM that will promote the melting of polymer binding fibers, consisting of low melting temperature polymers, is included below.

This type of structure may be preferably made by an airforming method. The composition of such a structure may be from about 1 to about 60 weight percent low melting point fiber, from about 0 to about 80 weight percent superabsorbent, and from about 5 to about 98 weight percent natural fibers. More particular embodiments have from about 4 to 12 weight percent low melting point fiber, 30 to 70 weight percent superabsorbent and 30 to 70 weight percent natural fiber. The nonwoven fibrous structure thus produced may have an average basis weight within the range of about 30-2500 gsm. The average basis weight of the fibrous structure can alternatively be within the range of about 50-2000 gsm, and can optionally be within the range of about 100-1500 gsm.

In the airlaying process a number of layers may be produced, the number of layers being set by the equipment constraints as most airlaying equipment currently available has at most four banks of airlaying heads. In such a case many of the properties of the web may be varied in the three dimensions of the web. The composition of the web, for example, may be varied in the Z-direction, and more or less binder fiber, natural fibers or superabsorbent place in the bottom or top areas of the web. The composition may likewise be varied in the X-Y plane across the width of the web, producing areas rich or poor in binder fiber, natural fibers or superabsorbent where desired by the producer.

In a similar manner, the density, basis weight and other properties of the web may be selected in order to produce a web that will most advantageously and cost-effectively meet the needs of the producer.

The fibrous web can be configured to have a varying, contoured basis weight with one or more high basis weight regions, and one or more low basis weight regions. In at least one high basis weight region, at least a significant portion of the fibrous web can have a composite basis weight which is at least about 700 gsm. The high basis weight region can alternatively have a basis weight of at least about 750 gsm, and can optionally have a basis weight of at least about 800 gsm to provide improved performance. In other aspects, the high basis weight region of the fibrous web can have a composite basis weight of up to about 2500 gsm, or more. The high basis weight region can alternatively have a basis weight of up to about 2000 gsm, and can optionally have a basis weight of up to about 1500 gsm to provide desired performance.

Additionally, in at least one low basis weight region, at least a significant portion of the fibrous web can have a composite basis weight is at least about 50 gsm. The low basis weight region can alternatively have a basis weight of at least about 100 gsm, and can optionally have a basis weight of at least about 150 gsm to provide improved performance. In another alternative, the low basis weight region of the fibrous web can have a composite basis weight of up to about 700 gsm, or more. The low basis weight region can alternatively have a basis weight of up to about 600 gsm, and can optionally have a basis weight of up to about 500 gsm to provide desired performance.

In still another aspect, the fibrous web can include an amount of binder fibers which is at least about 0.5 weight percent, as determined with respect to the total weight of the fibrous web. The amount of binder fibers can alternatively be at least about 1 weight percent, and can optionally be at least about 3 weight percent to provide improved performance. In other aspects, the amount of binder fibers can be up to a maximum of about 30 weight percent, or more. The amount of binder fibers can alternatively be up to about 20 weight percent, and can optionally be up to about 10 weight percent to provide an improved performance.

In a further aspect, the fibrous web departing the forming surface can be configured to have a density which is at least a minimum of about 0.01 g/cc, as determined at a restraining pressure of 1.38 KPa (0.2 psi). The density can alternatively be at least about 0.02 g/cc, and can optionally be at least about 0.03 g/cc to provide improved performance. In other aspects, the density of the fibrous web can be up to a maximum of about 0.12 g/cc, or more. The density can alternatively be up to about 0.11 g/cc, and can optionally be up to about 0.1 g/cc to provide improved effectiveness.

The fibrous web can be configured to be a substantially continuous, and substantially flat fibrous web. The fibrous web may be formed with substantially non-contoured, generally straight side edge regions, and with a substantially non-contoured thickness dimension. Additionally, the fibrous web may have a substantially uniform basis weight distribution.

In an alternative arrangement, the fibrous web can be configured to be a substantially continuous fibrous web which has been formed with substantially non-contoured side edge regions and with a selectively contoured thickness dimension. Accordingly, portions of the fibrous web can have a relatively lower thickness, and other portions of the fibrous web can have a relatively higher thickness. Additionally, portions of the fibrous web can have a relatively lower basis weight, and other portions of the fibrous web can have a relatively higher basis weight.

The fibrous web can be configured to be a discontinuous fibrous web which includes a serial plurality of separated web portions or segments. The separated portions of the discontinuous fibrous web can each be formed with substantially non-contoured, generally straight and generally parallel side edge regions. Additionally, each of the separated portions of the formed web can have a generally flat, and substantially non-contoured thickness dimension.

In another arrangement, the fibrous web can be configured to be a discontinuous fibrous web which has been formed with substantially non-contoured side edge regions and with a selectively contoured thickness dimension. Each separated portion of the discontinuous fibrous web can have a relatively-lower thickness region, and a relatively-higher thickness region. Additionally, each separate portion of the discontinuous fibrous web can have a relatively lower basis weight region, and a relatively higher basis weight region.

The fibrous web can be configured to be a substantially continuous fibrous web which has been formed with selectively contoured side edge regions and with a substantially non-contoured thickness dimension. The side edge regions of the fibrous web can be laterally contoured with a selected, undulating, serpentine outline shape.

In an alternative arrangement, the fibrous web can be configured to be a substantially continuous fibrous web which has been formed with selectively contoured side edge regions and with a selectively contoured thickness dimension. Accordingly, predetermined portions of the fibrous web can have a relatively lower thickness, and other portions of the fibrous web can have a relatively higher thickness. Additionally, portions of the fibrous web can have a relatively lower basis weight, and other portions of the fibrous web can have a relatively higher basis weight.

The fibrous web can be configured to be a discontinuous fibrous web which includes a serial plurality of separated web portions or segments. The separated portions of the discontinuous fibrous web can each be formed with laterally shaped side edge regions. Additionally, each of the separated web portions can be formed and with a generally flat and substantially non-contoured thickness dimension.

In still another arrangement, the fibrous web can be configured to be a discontinuous fibrous web which has been formed with selectively contoured side edge regions and with a selectively contoured thickness dimension. Accordingly, predetermined regions of each laterally shaped segment of the discontinuous fibrous web can have a relatively lower thickness, and other regions of each laterally shaped segment of the fibrous web can have a relatively higher thickness. Additionally, predetermined regions of each laterally shaped segment of the discontinuous fibrous web can have a relatively lower basis weight, and other regions of each segment of the discontinuous fibrous web can have a relatively higher basis weight.

The fibrous web can be configured to provide a fibrous web segment or pad in which the binder fiber is more heavily concentrated in a fibrous web stratum that was located relatively closer to and generally adjacent the forming surface employed by the method and apparatus. Accordingly, the web stratum that was closer to the forming surface, with the relatively higher concentration of binder fiber, can have a relatively higher strength, as compared to the other portions of the web.

The fibrous web can be configured to provide a fibrous web segment or pad in which the binder fiber is more heavily concentrated in a fibrous web stratum that was located relatively farther from the employed forming surface and relatively closer to and generally adjacent a free-surface side of the formed web. Accordingly, the web stratum that was farther from the forming surface, with the relatively higher concentration of binder fiber, can have a relatively higher strength, as compared to the other portions of the web.

The fibrous web can be configured to be a fibrous web segment or pad in which the binder fiber is more heavily concentrated in an intermediate-level fibrous web stratum and can optionally be configured to be a fibrous web segment or pad in which a first concentration of binder fiber is located in a first fibrous web stratum, and a different, second concentration of binder fiber is located in a second fibrous web stratum. Additionally, the binder fiber type may be different in different stratum of the web.

After the fibrous web is produced by, for example, the airforming process, a web transporter can deliver the fibrous web to a binder activation system. The activation system generally has an activation chamber that can produce a standing wave. In a particular feature, the activation chamber can be configured to be a resonant chamber. Examples of suitable arrangements for the resonant, activation chamber system are described in a U.S. Pat. No. 5,536,921 entitled SYSTEM FOR APPLYING MICROWAVE ENERGY IN SHEET-LIKE MATERIAL by Hedrick et al. which has an issue date of Jul. 16, 1996; and in U.S. Pat. No. 5,916,203 entitled COMPOSITE MATERIAL WITH ELASTICIZED PORTIONS AND A METHOD OF MAKING THE SAME by Brandon et al which has a issue date of Jun. 29, 1999.

The total residence time within the activation chamber or chambers can provide a distinctively efficient activation period. In a particular aspect, the activation period can be at least a minimum of about 0.002 sec. The activation period can alternatively be at least about 0.005 sec, and can optionally be at least about 0.01 sec to provide improved performance. In other aspects, the activation period can be up to a maximum of about 3 seconds. The activation period can alternatively be up to about 2 sec, and can optionally be up to about 1.5 sec to provide improved effectiveness.

The activation of the binder fibers and/or other web materials to form the desired stabilized structures can be performed at higher speed, and can be conducted with shorter activation times, than conventional infrared/convection heating, as noted above. For example, the activation can be conducted with shorter heating times and shorter cooling times. Additionally, the activation operation can be quickly turned on and off, as desired to accommodate any stops and starts of the method and apparatus. As a result, the activation operation can be conducted along a distinctively short length of processing space. This can allow a more compact arrangement, that can be more readily incorporated into an on-line manufacturing process. In particular configurations, the method and apparatus can produce an airlaid, stabilized fibrous web that has a selectively contoured basis weight and/or a selectively contoured shape. Additionally, the process and apparatus can more efficiently provide a stabilized web having a selectively contoured density. The process and apparatus can also more efficiently provide a stabilized web having a contoured cross-directional width, wherein the width of the stabilized web can vary between relatively wide and relatively narrow, as one moves along a longitudinal length of the web.

The great flexibility of the airforming process combined with the flexibility of the electromagnetic activation system, can allow product designers much leeway in the design of personal care products.

Superabsorbents that are useful in the present inventions can be chosen from classes based on chemical structure as well as physical form. These include superabsorbents with low gel strength, high gel strength, surface cross-linked superabsorbents, uniformly cross-linked superabsorbents, or superabsorbents with varied cross-link density throughout the structure. Superabsorbents may be based on chemistries that include poly(acrylic acid), poly(iso-butylene-co-maleic anhydride), poly(ethylene oxide), carboxy-methyl cellulose, poly(-vinyl pyrrollidone), and poly(-vinyl alcohol). The superabsorbents may range in swelling rate from slow to fast. The superabsorbents may be in the form of foams, macroporous or microporous particles or fibers, particles or fibers with fibrous or particulate coatings or morphology. The superabsorbents may be in the shape of ribbons, particles, fibers, sheets or films. Superabsorbents in the form of particles are preferred for the practice of this invention. Superabsorbents may be in various length and diameter sizes and distributions. The superabsorbents may be in various degrees of neutralization. Counter-ions are typically Li, Na, K, Ca.

An exemplary superabsorbent was obtained from Stockhausen, Inc and is designated FAVOR® SXM 880. Another example of these types of superabsorbents may be obtained from the Dow Chemical Company under the name DRYTECH® 2035. An example of fibrous superabsorbents may be obtained from Camelot Technologies, Ltd., of High River, Alberta, Canada and is designated FIBERDRI® 1241. Another Example included in these types of superabsorbents is obtained from Chemtall Inc. or Riceboro, Ga., and is designated FLOSORB 60 LADY®, also known as LADYSORB 60®. Additional types of superabsorbents not listed here which are commonly available and known to those skilled in the art can also be useful in the present inventions.

Natural fibers include wool, cotton, bagasse fibers, milkweed fluff fibers, wheat straw, kenaf, hemp, pineapple leaf fibers, peat moss flax and wood pulp. Wood pulps include standard softwood fluffing grade such as NB-416 (Weyerhaeuser Corporation, Tacoma, Wash.) and CR-1654 (US Alliance Pulp Mills, Coosa, Ala.), bleached kraft softwood or hardwood, high-yield wood fibers, ChemiThermoMechanical Pulp fibers and Bleached Chemithermal Mechanical Pulped (BCTMP). Pulp may be modified in order to enhance the inherent characteristics of the fibers and their processability. Curl may be imparted to the fibers by methods including chemical treatment or mechanical twisting. Curl is typically imparted before crosslinking or stiffening. Pulps may be stiffened by the use of crosslinking agents such as formaldehyde or its derivatives, glutaraldehyde, epichlorohydrin, methylolated compounds such as urea or urea derivatives, dialdehydes such as maleic anhydride, non-methylolated urea derivatives, citric acid or other polycarboxylic acids. Some of these agents are less preferable than others due to environmental and health concerns. Pulp may also be stiffened by the use of heat or caustic treatments such as mercerization. Examples of these types of fibers include NHB416 which is a chemically crosslinked southern softwood pulp fibers which enhances wet modulus, available from the Weyerhaeuser Corporation of Tacoma, Wash. Other useful pulps are debonded pulp (NF405) also from Weyerhaeuser. HPZ3 from Buckeye Technologies, Inc of Memphis, Tenn., has a chemical treatment that sets in a curl and twist, in addition to imparting added dry and wet stiffness and resilience to the fiber. Another suitable pulp is Buckeye HPF2 pulp and still another is IP SUPERSOFT® from International Paper Corporation. Suitable rayon fibers are 1.5 denier Merge 18453 fibers from Tencel Incorporated of Axis, Ala.

In the practice of this invention, a mixture of fibers is produced and stabilized through the use of electromagnetic energy, such as radio frequency (RF) and microwave energy. This energy is absorbed by components in the superabsorbent and natural fibers, and to some extent by the low melt temperature fibers. Energy absorbing components in the superabsorbent and natural fibers include most predominately water, and also energy receptive moieties associated with the superabsorbent molecules. As noted above, the low melting point fiber itself may be made more energy receptive through the use of energy receptive additives, though such additives are not required for the practice of this invention. An exemplary process for the production and stabilization of the structures of this invention is that of U.S. patent application Ser. No. _______, attorney docket 16820, filed on the same day as this application and co-assigned.

Another embodiment of the instant invention is as a coating of the low melting point polymers and blends with or without energy receptive additives, onto conventional fibers. The low melting polymer may also be fiberized as a bicomponent or biconstituent fiber. The advantages of this are that the bicomponent low melting fiber does not need as much energy for melting as, for example, a polypropylene fiber and the core fiber can provide strength to the fiber. This can protect the nonwoven structure from crushing after bonding. In addition, a surface coating can provide tackyness for adhesion after melting. Lastly, low melting point polymer/blend coatings may be sensitive to microwave/or other thermal energy.

It is alternatively desirable that energy receptive materials be added to the natural fiber and SAM matrix to make it even more receptive to microwave energy. Examples of materials that may be suitable for addition to the matrix followed by their dielectric constants are: cellulose (3.2-7.5), cellulose acetate (3.2-7.0), wet clays (2.0-10.0), cotton (1.5-5.0), cellulose containing glycols (3.5-20.0), cellulose containing gycerols (3.5-22.0), cellulose containing graphite (3.5-8.0), sodium or potassium polyacrylate (2.0-7.0), microwave ready paper pulp (3.2-7.5), paper pulp containing glycols (3.5-20.0), paper pulp containing gycerols (3.5-22.0), and paper pulp containing graphite (3.5-8.0). These materials may be added to the matrix in an effective amount to heat the matrix at the desired rate. Particular amounts in which the materials may be added to the matrix, if desired, are from 5 to about 25 weight percent of the structure, more particularly between 7 and 15 weight percent.

Samples were made for a number of matrix materials. All samples tested were received as pellets or fibrous bulk samples. All samples were made into compressed sheets of approximately 1 millimeter thickness before measurement. Table 1 gives the dielectric loss factor and the dielectric loss tangent of each matrix sample at the frequencies of 915 and 2450 at 25° C., as tested according to the test procedure given above. Table 1 shows measured dielectric properties for some representative matrix materials. Note: The higher the value for each of these relative values, particularly dielectric loss and dielectric loss tangent, the higher the relative affinity of the matrix material to microwave heating.

TABLE 1

| | 915 | 915 | | 2450 | 2450 | |
|---|---|---|---|---|---|---|
| | MHz | MHz | loss | MHz | MHz | loss |
| Sample ID | ε′ | ε″ | tangent | ε′ | ε″ | tangent |
| Polyethylene | 2.49 | 0.002 | 0.001 | 2.38 | 0.002 | 0.001 |
| Dry | 2.04 | 0.10 | 0.0490 | 1.84 | 0.13 | 0.0707 |
| Cellulose | | | | | | |
| Pulp | | | | | | |
| fibrous | | | | | | |
| Dry | 1.56 | 0.30 | 0.1900 | 1.45 | 0.13 | 0.0900 |
| Polyacrylate | | | | | | |
| (SAM) | | | | | | |
| Natural pulp | 2.56 | 0.97 | 0.3800 | 2.32 | 0.69 | 0.3000 |
| (rough | | | | | | |
| texture | | | | | | |
| Natural pulp | 1.82 | 0.35 | 0.1900 | 1.70 | 0.22 | 0.1300 |
| (smooth | | | | | | |
| texture | | | | | | |
| Dry | 1.75 | 0.05 | 0.0286 | 1.54 | 0.07 | 0.0455 |
| Cellulose | | | | | | |
| Tissue | | | | | | |
| (layered) | | | | | | |
| Dry | 1.85 | 0.05 | 0.0270 | 1.66 | 0.04 | 0.0241 |
| Cellulose | | | | | | |
| fluff (fibrous) | | | | | | |
| Water, 0° C. | | | | 88.0 | 25.0 | 0.284 |
| Water, 25° C. | | | | 77.5 | 12.2 | 0.157 |
| Water, 100° C. | | | | 1.00 | 0.001 | 0.001 |
| Commercial | 1.80 | 0.14 | 0.0800 | 1.60 | 0.13 | 0.0800 |
| Paper Towel | | | | | | |
| (Dry) | | | | | | |

Matrix materials with the highest roughness and greatest moisture content tend to exhibit the highest dielectric loss and heating rate. These materials exhibit enhanced microwave-receptivity where the heating rate for a rough texture natural pulp is nearly three times that of dry and smooth materials. Correspondingly, this matrix material requires less power input to generate an equivalent heating rate. The moisture content of natural fibers suitable for this invention, therefore, is between 1 and 20 weight percent of the natural fibers, more particularly between 5 and 15 weight percent and still more particularly between 7 and 12 weight percent.

Note that the complex permittivity measures the ability of a material to absorb and store electrical potential energy. The real permittivity or dielectric constant (∈′) is a measure of the relative ease of penetration of a microwave field into a material. The dielectric loss factor (∈″) indicates the energy storage ability of a material. The loss tangent (tanδ) is a value indicative of a material's capacity to absorb microwave energy and convert it to heat. Loss tangents of 0.1 to 1.0 are ideal for microwave coupling for heating in this application.

For optimum coupling with a microwave field a material must exhibit a medium dielectric constant (∈′) in concert with a high dielectric loss factor (∈″). The resulting loss tangent (tanδ=∈″/∈′) is an indicator of optimized coupling for microwave energy available for heating a material. An additional characteristic of materials optimally heated using an applied microwave field is a medium to high thermal conductivity combined with an appropriate density in concert with a dielectric loss that does not increase dramatically with temperature. Note that as water changes to steam the loss drops to near zero making it transparent to microwaves and actually part of an evaporative cooling process. In heating via convection or infrared radiant heat transfer the steam continues to absorb energy and heat causing elevated temperatures for longer periods than required to melt the bond points. This increased period of elevated temperature only serves to increase degradation of the polymers resulting in increased oxidative weakening of the structure. The water within the structure can be preconditioned for uniform distribution and dielectric loss to provide an optimum platform for dielectric heating. From Table 1 it can be seen that water exhibits different dielectric loss and loss tangent characteristics dependent upon temperature. The optimum moisture content is determined using a calculation of the upper moisture limit for the structure being heated. The optimum moisture content is just below (more than 1 percent by weight) from the determined upper moisture limit. To calculate the upper moisture limit, a thermocouple is included within a series of structures with varying water content, and at a fixed starting temperature. The microwave field is applied until a moisture content is reached where runaway heating occurs indicated by a rapidly increasing temperature rate. The temperature is plotted as the ordinate with the time of the applied microwave field as the absicca (δT/δt). The point where there is a rapid increase in the slope (δT/δt) is the upper moisture limit under the specific application being tested. Alternatively the upper moisture limit can be directly measured by determining the dielectric loss for a series of moisture levels within a matrix at a series of temperatures from 50° C. to 100° C. The results are plotted as δ∈″/δμ where μ is the moisture content. The upper moisture limit for the system under test is the point where a large change in δ∈″/δμ occurs. Thus the ideal moisture content for a specific structure and dielectric heating mode can be determined.

The rate of change in temperature of a structure heated using dielectric heating can be predetermined from a measure of the dielectric loss using

$$\frac{Δ T}{t} = \frac{2 π {ϵ}_{01} v {ϵ}^{″} {E}^{2}}{{k}_{h} {WC}_{p}} \qquad ( 1 )$$

And an additional computational form for calculating an increase in temperature relative to a material, given a specific dielectric field strength (E) with ν in units of Hz (cycles per second), is given by

$$\frac{Δ T}{t} = \frac{( 8 \times {10}^{- 12} ) v {ϵ}^{″} {E}^{2}}{{dC}_{p}} \qquad ( 2 )$$

Where C_{P} is the specific heat of the target material (in cal.·g⁻¹)

d is the density of the target material (in g·cm⁻³)

E is the rms value of the applied electric field (in volts·cm⁻¹)

∈″ is designated here as the measured dielectric loss of a material

kₕ is a proportionality constant for unit conversion equal to 4.186 for GHz and 4186 for MHz

ν(nu) is the frequency of the applied microwave field (in MHz)

t is the time duration of an applied field (in seconds)

ΔT is a unit temperature change in the target (in °C·sec.⁻¹)

W is the weight of the sample target (in grams)

Regardless of the manner of making the absorbent structure more receptive to microwaves, the resultant bonded structure has unique physical characteristics that indicate the bonding method. A structure bonded in a conventional thermal process, i.e., by convection or infrared radiant heat transfer, for example, will exhibit a heating gradient where the greatest heating occurs on the exterior or extremities decreasing with depth to a minimum at the center. For this heating process the greater oxidation of the fibers occurs on the outside of the structure, since heating by convection and conduction occurs from the outside of the structure toward the center. Dielectric heating, i.e., heating by Radio frequency or microwave radiation, creates a heating gradient whereby the maximum heating occurs from the center of the structure, decreasing towards the outer extremities, making oxidation of the outer fibers less than that of heating by convection or infrared radiant heat transfer. Conventional thermal bonding also results in some yellowing of the outer fibers that is not apparent in Radio frequency or microwave radiation heating. Lastly, dielectric heating results in a structure that is more uniformly bonded than the same structure bonded by convection or convection or infrared radiant heat transfer. The absorbent structure of this invention is therefore, relatively uniformly bonded from the center (when compared to the same structure bonded by conventional thermal convection and infrared radiant heat transfer means). The heating occurs at a faster rate using the dielectric heating and the oxidative processes causing yellowing and discoloration are therefore minimized and the bonding structural integrity at the center regions of the heated material is maximized. The microwave heating will occur in from 5 to 30 percent of the rate required for convection or infrared radiant heat transfer reducing the time at elevated temperature.

For convection and infrared radiant heat transfer any liquid water within the matrix moves toward the surface of the fibrous matrix and bulk structure at the water diffusion rate of the structure itself. The passive diffusion rate is proportional to the material matrix density. In contrast, dielectric heating raises the internal temperature rapidly driving water to the outside surface via an active transport. Thus the overall transfer of heat from the water to the surrounding material occurs actively not passively. The end result is more rapid and uniform heating of the structure. A factor having a large effect on the dielectric heating properties of the matrix, given a specific structure, is the water content and distribution. The active transport of the water provides a more uniform distribution of the heating throughout the structure.

The various structures provided using different heating techniques are qualified and quantified using measurements of location and degree of oxidation and bonding efficiency within the polymer blend matrix. Techniques such as ultraviolet, visible, near infrared, infrared and Raman spectroscopy; surface analysis; differential scanning calorimetry; chromatographic separation; and various microscopic techniques can demonstrate the unique properties of materials heated “externally” via convection or infrared radiant heat transfer, versus “internal” heating using dielectric techniques.

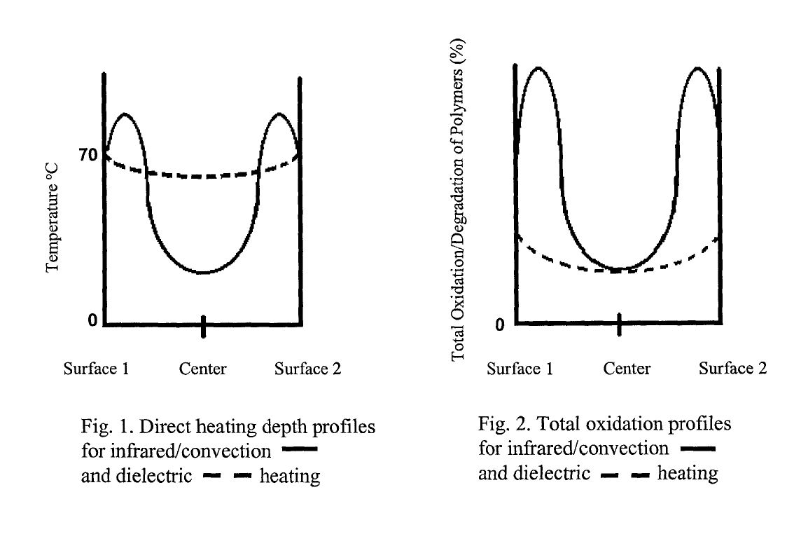

With infrared and convection heating the radiant energy is directly translated to heat at the surface layers where the surface temperature rises rapidly. The heat created at the outer surfaces eventually diffuses by thermal conduction toward the center. This heating process is relatively slow and it takes significant time for the center of a structure to reach the threshold temperature necessary to begin to melt the binder fibers. The slow process of thermal conduction is dependent upon the thermal conductivity of the structure and its overall dimensions (thickness). For dielectric heating the peak temperature is also near the surface but the temperature rise at the center is nearly identical to the outer surface-heating rate. This occurs since the dielectric heating process is active and direct. This direct transfer of energy to the center of an object is less dependent upon thermal conductivity and more dependent upon the dielectric field strength and dielectric properties of the material. For a comparison of the heating depth profiles for infrared/convection versus dielectric heating see FIG. 1. This figure illustrates the spatial areas in a structure where direct heating occurs. In FIG. 1, the temperature in °C is on the Y-axis, the first surface is on the left side and the second surface on the right side with the material's center centered between the two surfaces. The dashed line indicates the heating profile for dielectric heating and the solid line indicates the heating profile for infrared/convection heating. As can be seen from FIG. 1, there is a much greater variation in the temperature profile for infrared/convection heating than for dielectric heating.

In order to achieve the desired equivalent internal temperature, infrared energy must be applied from 3 to 30 times longer than dielectric heating. This extended heating is required in order to attain a pre-specified temperature threshold at the center. When properly applied, dielectric heating occurs rapidly and more uniformly. The rapid and uniform direct heating prevents large-scale thermal degradation of polymers within heated structures.

The percent oxidation occurring for any given structure is proportional to the time exposure of the polymer to air at an elevated temperature (i.e., above 75° C.). Infrared heating maintains a higher surface temperature throughout the heating cycle than microwave heating. The projected percent oxidation from infrared and convection heating will be from 5 to 35 (or more) times greater at the surface than it would be at the surface in dielectric heating. Heating by microwave radiation will, therefore, produce a structure having less than 5 times more oxidation at its outer surface than at its center and more particularly less than 3 times more oxidation at its outer surface than at its center.

A typical comparison of the total oxidation/degradation occurring to polymer samples heated using infrared/convection heating versus dielectric heating is illustrated in FIG. 2. In FIG. 2, the percentage of oxidation is on the Y-axis, the first surface is on the left side and the second surface on the right side with the material's center centered between the two surfaces. The dashed line indicates the oxidation profile for dielectric heating from surface to surface and the solid line indicates the oxidation profile for infrared/convection heating. As can be seen from FIG. 2, there is a much greater variation in the oxidation profile for infrared/convection heating than for dielectric heating. (Note: Improper use of any known heating technique will cause degradation and destruction of the material being heated.)

Large differences in oxidative degradation due to surface heating are easily measured using the analytical techniques previously described. For this application, typical compounds resulting from oxidative degradation include the existence of highly colored (high molar absorptivity) species. These colored compounds result from the formation of identifiable unsaturation. Examples include polyenes, unsaturated ketones, carboxyl-containing organic chains, quinones, and in general compounds with conjugated double bonds formed by the oxidation/degradation mechanisms of free radical formation, elimination reactions, and random chain scission. Often the increased oxidation can readily be observed with the unaided eye, making the materials heated using infrared and convection heating appear more yellow and thus of perceived lower quality.

A rapid, non-destructive method to analyze polyolefins and cellulosic materials for the presence of compounds resulting from thermal degradation is described. The ultraviolet and visible spectrum is measured on a control and heated sample. The resulting spectra are subtracted and the difference spectra compared to a series of reference sample spectra prepared by heating a series of comparison samples at elevated temperatures for different known periods to bracket the heating application. The spectra yield direct information on the color and molecular absorptive properties of the thermal degradation products present in polymers and cellulose. The ratios of the absorbance maximum for the ultraviolet versus the visible spectrum yields precise information on the chemical species present and on the approximate concentrations. This basic procedure can be reproduced using ultraviolet and visible fluorescence, Raman spectroscopy, and infrared spectroscopy for similar and complementary results.

For more detailed structural analysis, the polymer and cellulosic materials can be dissolved in appropriate solvents, subjected to liquid chromatographic separation, and further analyzed using either the spectroscopic techniques described above or by mass spectrometry to determine the structure and molecular weight of any degradation compounds. These compounds are often highly colored as yellow or brown due to the browning effect of thermal degradation oxidation. There is a plethora of literature describing the detailed analysis of degradation compounds in synthetic and natural polymers and most of these techniques are quite sufficient for measuring the relative amount of oxidation throughout the cross-section of the heated structure. In addition, the use of scanning electron microscopy with osmium tetroxide staining will reveal the integrity of bond points within the structure indicating the maximum heating temperature reached in any portion of the heated structure during the process.

As will be appreciated by those skilled in the art, changes and variations to the invention are considered to be within the ability of those skilled in the art. Examples of such changes and variations are contained in the patents identified above, each of which is incorporated herein by reference in its entirety to the extent consistent with this specification. Such changes and variations are intended by the inventors to be within the scope of the invention.

What is claimed is:

1. A nonwoven structure comprising binder fibers made from a polymer having a melting point of at most 110° C., wherein said structure has a center and an outer surface and wherein said structure has less than 5 times more oxidation at said outer surface than at said center.

2. The nonwoven structure of claim 1 wherein said structure has less than 3 times more oxidation at said outer surface than at said center.

3. The nonwoven structure of claim 1 further comprising superabsorbent.

4. The nonwoven structure of claim 3 further comprising natural fibers.

5. The nonwoven structure of claim 1 wherein said binder fiber polymer is selected from the group consisting of low density PE/polyethylene-polyvinylacetate block copolymer, LDPE/polyethylene glycol, PE/polyacrylates, polyethylene-vinyl acetate copolymer, polyester, polycaprolactone, polyurethane, polyacrylates, polyethylene glycol (PEG), polyacrylamide (PAA), polyethylenimine (PEEM), polyvinyl acetate (PVAC), polyvinyl alcohol (PVA), polymethylacylic acid-sodium salt (PMA-Na), polyacylic acid sodium salt (PA-Na), and poly (styrene solfonate-co-methyl acylic acid) sodium salt (P (SS-co-MA)-Na.

6. The nonwoven structure of claim 1 wherein said binder fiber has a melting point of at most 90° C.

7. The nonwoven structure of claim 1 wherein said binder fiber has a melting point of at most 80° C.

8. The nonwoven structure of claim 1 wherein said binder fiber is a biconstituent fiber.

9. The nonwoven structure of claim 1 wherein said binder fiber further comprises an energy receptive additive having a dielectric loss of at least 0.5.

10. The nonwoven structure of claim 1 wherein said binder fiber further comprises an energy receptive additive having a dielectric loss of at least 1.

11. The nonwoven structure of claim 1 wherein said binder fiber further comprises an energy receptive additive having a dielectric loss of at least 5.

12. The nonwoven structure of claim 9 wherein said energy receptive additive is selected from the group consisting of carbon black, magnetite, silicon carbide, calcium chloride, zircon, magnetite, silicon carbide, calcium chloride, alumina, magnesium oxide, and titanium dioxide.

13. The nonwoven structure of claim 12 wherein said energy receptive additive is present in an amount between 2 and 40 weight percent.

14. The nonwoven structure of claim 12 wherein said energy receptive additive is present in an amount between 5 and 15 weight percent.

15. The structure of claim 4 wherein said superabsorbent, natural fibers and binder fibers are homogeneously mixed.

16. The structure of claim 4 wherein said superabsorbent, natural fibers and binder fibers are heterogeneously mixed.

17. The structure of claim 16 wherein said binder fibers vary in concentration in an X-Y plane.

18. The structure of claim 16 wherein said binder fibers vary in concentration in a Z direction.

19. The structure of claim 4 having a density, wherein said density varies in an X-Y plane.

20. The structure of claim 4 having a density, wherein said density varies in a Z-direction.

21. The structure of claim 4 having a thickness, wherein said thickness varies in an X-Y plane.

22. The structure of claim 4 wherein said binder fiber varies in concentration in an X-Y plane.

23. The structure of claim 4 wherein said binder fiber varies in concentration in a Z-direction.

24. A nonwoven structure comprising superabsorbent in an amount of from 0 to 80 weight percent, natural fibers in an amount from about 5 to 98 weight percent and low melting point binder fibers in an amount of from about 1 to 60 weight percent, wherein said low melting point fiber has a melting point of at most 110° C., said structure has a center and an outer surface, and wherein said structure has less than 5 times more oxidation at said outer surface than at said center.

25. The nonwoven structure of claim 24 wherein said superabsorbent is in a form selected from the group consisting of ribbons, particles, fibers, sheets and films.

26. The nonwoven structure of claim 24 wherein said natural fiber is selected from the group consisting of wool, cotton, flax, hemp and wood pulp.

27. A nonwoven structure comprising from about 4 to 12 weight percent of a binder fiber having a melting point of at most 110° C., 30 to 70 weight percent superabsorbent and 30 to 70 weight percent natural fiber, wherein said structure has been subjected to microwave radiation to activate said binder fiber and bond said structure.

28. The nonwoven structure of claim 27 having a basis weight of about 30-2500 gsm.

29. The nonwoven structure of claim 28 wherein said binder fiber further comprises an energy receptive additive having a dielectric loss of at least 5.
